(19) United States
(12) Patent Application Publication
(10) Pub. No.: US 2005/0060596 A1
(43) Pub. Date: Mar. 17, 2005

(54) Device and method that automatically adjust CPU work frequency

(76) Inventor: An-Sheng Chang, Taichung Hsien (TW)

Correspondence Address: BIRCH STEWART KOLASCH & BIRCH, PO BOX 747, FALLS CHURCH, VA, 22040-0747, US

(21) Appl. No.: 10/663,658

(22) Filed: Sep. 17, 2003

(51) Int. Cl. G06F 1/04

(52) U.S. Cl. 713/600; 713/322

(57) ABSTRACT

A device and a corresponding method that automatically adjust the CPU Work frequency are disclosed. The device uses at least one sensor to monitor the work status of a host in real time. According to the user's settings, it automatically adjusts the work frequency of the host. The device comprises at least one host sensor, a setting unit, a storage unit, a comparing unit and a frequency adjusting unit. The disclosed method first starts the host sensor(s), sets the trigging conditions for frequency adjustments, monitors the sensor(s) to detect its status values, compares the triggering conditions and the sensor status values, and immediately adjusts the work frequency according to the comparison result.

### BACKGROUND OF THE INVENTION

1. Field of Invention

The invention relates to a device and method for automatically adjusting frequencies and, in particular, to a device and method for automatically adjusting the CPU work frequency of a computer system.

2. Related Art

In current personal computer (PC) systems, the central processing unit (CPU) work frequency is mostly fixed, independent of the temperature, voltage, and electric current variations or software running on the host. It looks that such systems can ensure the stability of the work frequency. However, it is not quite true. The computer is actually a dynamical system while it runs. The executing programs, voltage and temperature variations continuously change as the size of the loaded program and the system resources vary. If the running time is too long or the program load is too heavily for the system resources, the system internal temperature increases. In this case, the work frequency of the system has to be reduced in order to relax the system's burden. When situations of too large the voltages happen, it is also necessary to reduce the work frequency of the system. Alternatively, if more programs are loaded, the CPU work frequency should be appropriately increased. On the other hand, once these situations disappear, the work frequency should be returned to normal.

Nevertheless, current PC systems do not have such automatic frequency adjustment functions. Therefore, their work frequencies cannot be modified according to the operation environment. This will make the system performance unsatisfactory. Therefore, the automatic frequency adjustment function in PC systems has become an important issue in the field.

### SUMMARY OF THE INVENTION

To solve the above-mentioned problem, the invention provides a device and a corresponding method that can automatically adjust the CPU work frequency in a PC system, so that the CPU work frequency changes as the operation environment varies.

The invention provides a method of automatically adjusting the CPU work frequency for a computer system. It first starts a sensor, sets triggering conditions for adjusting the frequency, performs comparison between the status values detected by the sensor and the triggering conditions, and immediately adjusts the CPU work frequency according to the comparison result.

The invention further provides a device of automatically adjusting the CPU work frequency for a computer system. It includes at least a set of sensor for detecting the host work status, a setting unit for setting triggering conditions to adjust the frequency, a storage unit for storing the triggering conditions, a comparing unit for comparing the host work status detected by the sensor with the triggering conditions stored in the storage unit, and a frequency adjusting unit for adjusting the work frequency of the host according to the comparing unit.

The disclosed device and method use the sensor to monitor the changes in the host work status in real time. When the changes exceed the predetermined triggering conditions, the invention automatically adjust (increase or decrease) the CPU work frequency in order to suitably react to the changing operation environment. Thus, the CPU can reach its optimal condition.

### BRIEF DESCRIPTION OF THE DRAWINGS

The invention will become more fully understood from the detailed description given hereinbelow illustration only, and thus are not limitative of the present invention, and wherein:

FIG. 1 is a flowchart of the disclosed method of automatically adjusting the work frequency; and

FIG. 2 is a structural view of the disclosed device of automatically adjusting the work frequency.

### DETAILED DESCRIPTION OF THE INVENTION

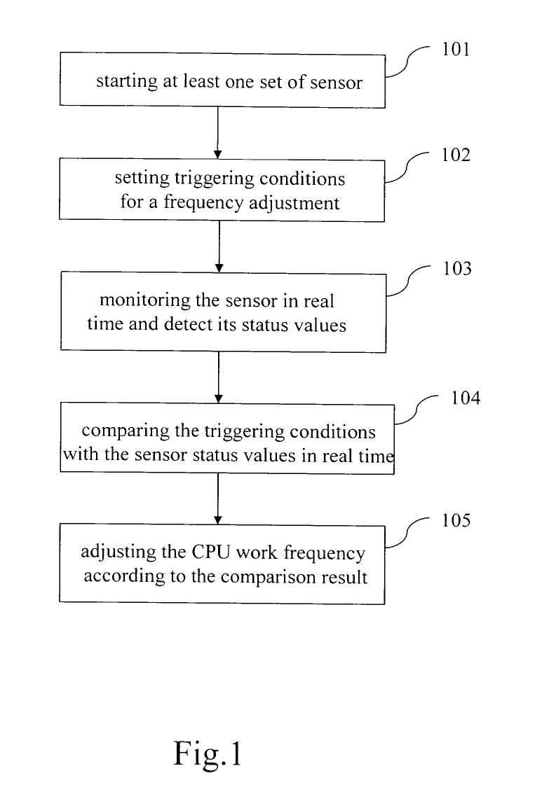

With reference to FIG. 1, the disclosed method first starts a sensor (step 101). Afterwards, it sets triggering conditions for frequency adjustments (step 102). It monitors the sensor and detects its status values (step 103). It then compares the triggering conditions and the sensor status values (step 104). Finally, it adjusts the CPU work frequency according to the comparison result in real time (step 105).

The sensor can be a voltage, electric current, temperature or load sensor, or their combinations. Each of the sensors has its own monitoring module for monitoring the host system in real time and producing its detected value(s).

The triggering condition(s) can be a single condition for each individual sensor or a combination of conditions for several sensors.

The triggering conditions can be set and stored in the computer system by the computer manufacturer while production. They can also be reset by the user when the machine is turned on.

The system uses the triggering conditions set as described above to determine whether the CPU frequency should be adjusted. The adjustment can be either way: increasing or decreasing the frequency. Of course, if the work environment does not reach the predetermined triggering conditions, the system maintains its CPU work frequency.

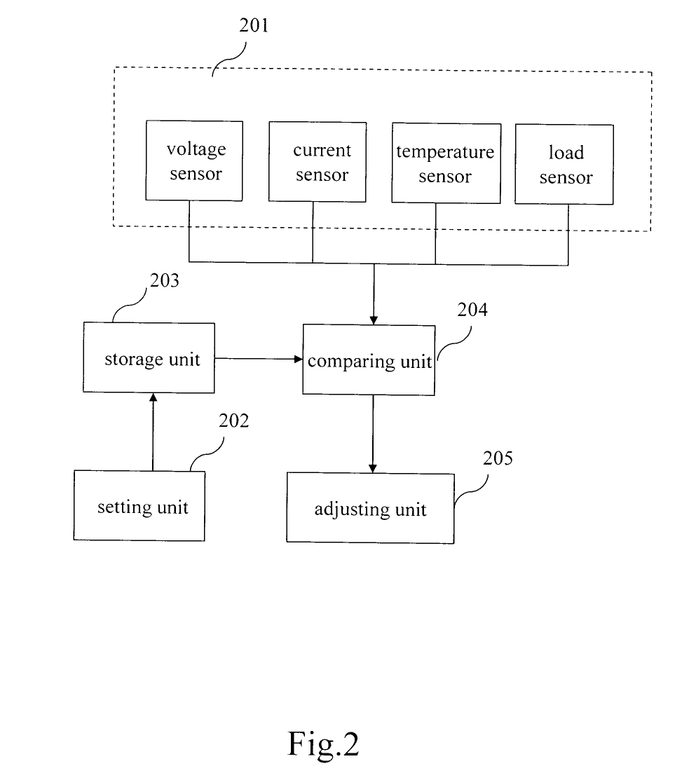

With reference to FIG. 2, the disclosed device of automatically adjusting the CPU work frequency has at least one set of sensor 201, a setting unit 202, a storage unit 203, a comparing unit 204, and a frequency adjusting unit 205.

The sensor 201 detects the work status of the host machine and outputs a set of detected values. The setting unit 202 is used to set the triggering conditions for frequency adjustments. The storage unit 203 stores the triggering conditions set by the setting unit. The comparing unit 204 compares the host work status detected by the sensor(s) with the triggering conditions stored in the storage unit. The frequency adjusting unit 205 follows the comparison result to adjust the work frequency of the host.

The host is installed with at least one set of sensor 201. The sensor can be a voltage sensor, an electric current sensor, a temperature sensor, a load sensor, or a combination of these sensors. The sensor(s) 201 are installed at key location(s) of the host system. The use of several sensors can more accurately detect the operation changes of the host. These sensors are equipped with their own monitoring modules to detect the voltage, electric current, temperature, and program load of the host in real time and to send the status changes to the system.

The user can set the sensors of the system via the setting unit 202 when turning on the machine. He or she can further provide several triggering condition combinations according to different demands and store the triggering conditions inside the storage unit 203. Afterwards, the system uses the comparing unit 204 to compare the triggering conditions set by the user and the system information collected by the sensors 201, using the comparison result to determine whether to increase or decrease the CPU frequency.

When the host has to process a heavy-load program or a very time-consuming program in any operating system, the system automatically adjusts the CPU frequency according to the needs. Once the system returns to its normal state or finishes processing the program, the system automatically switches its CPU frequency back to its normal frequency. The whole switching process does not require any software or restarting the system. The switching process does not affect running programs either.

The invention can be solely used as a temperature monitor. When the host temperature is too high, the system automatically adjusts its frequency to lower the host temperature. When the host temperature is lower than a predetermined temperature, the system then works at a higher frequency. The invention has a fast reaction time and no compatibility problems. There is no need to restart the host in order to modify or set the sensors in any operating system. Therefore, the invention achieves the highest stability and efficiency.

Certain variations would be apparent to those skilled in the art, which variations are considered within the spirit and scope of the claimed invention.

1. A method of automatically adjusting the central processing unit (CPU) work frequency comprising the steps of:
starting at least one set of sensor:
setting triggering conditions for a frequency adjustment;
monitoring the sensor in real time and detect its status values:
comparing the triggering conditions with the sensor status values in real time; and
adjusting the CPU work frequency according to the comparison result in real time.

2. The method of claim 1, wherein the sensor is selected from the group consisting of a voltage sensor, an electric current sensor, a temperature sensor, and a load sensor.

3. The method of claim 1, wherein the triggering conditions include a single condition for a single sensor and a plurality of conditions for a plurality of sensors.

4. The method of claim 1, wherein the triggering conditions are predetermined and stored in the computer system during production.

5. The method of claim 1, wherein the triggering conditions are set by the user when power on and stored in the computer system.

6. The method of claim 1 wherein the CPU frequency adjustment includes increasing and decreasing the frequency.

7. A device of automatically adjusting the CPU work frequency comprising:
at least one sensor, which detects the work status of a host machine and outputs a detected value;
a setting unit, which sets triggering conditions for a frequency adjustment;
a storage unit, which stores the triggering conditions set by the setting unit;
a comparing unit, which compares the detected value output from the sensor and the triggering conditions stored in the storage unit; and
a frequency adjusting unit, which modifies the CPU work frequency according to the comparison result of the comparing unit.

8. The device of claim 7, wherein the sensor is selected from the group consisting of a voltage sensor, an electric current sensor, a temperature sensor, and a load sensor.
